(19) United States
(12) Patent Application Publication
(10) Pub. No.: US 2008/0168866 A1
(43) Pub. Date: Jul. 17, 2008

(54) METHOD OF MANUFACTURING HONEYCOMB STRUCTURE-BODY MOLDING DIE

(75) Inventor: Masahiko BABA, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/013,545

(22) Filed: Jan. 14, 2008

(30) Foreign Application Priority Data
Jan. 16, 2007 (JP) 2007-006994

(51) Int. Cl. B21K 5/20; B23P 13/04

(52) U.S. Cl. 76/107.1; 29/558; 425/465

(57) ABSTRACT

A method of manufacturing a honeycomb structure-body molding die formed with material feed holes and slit recesses formed in a lattice pattern in communication with the material feed holes, respectively, for molding the material into a honeycomb shape is disclosed. The method comprises a preparing step, a feed-hole forming step and a slit-recess forming step. In the slit-recess forming step, grinding work is conducted using a disc-like thin-blade grinding stone to form non-communication slit recesses on the slit-processing surface each in a depth not to communicate with the material feed holes (in a non-communication grinding process). Then, the grinding work is further conducted to grind the non-communication slit recesses into the slit recesses until the slit recesses are brought into communication with the material feed holes (in a communication grinding process).

### CROSS REFERENCE TO RELATED APPLICATIONS

This application is related to Japanese Patent Application No. 2007-6994, filed on Jan. 16, 2007, the content of which is hereby incorporated by reference.

### BACKGROUND OF THE INVENTION

1. Technical Field of the Invention

The present invention relates to methods of manufacturing honeycomb structure-body molding dies and, more particularly, to a method of manufacturing a honeycomb structure-body molding die for use in molding a honeycomb structure body.

2. Description of the Related Art

Honeycomb structure bodies, used for exhaust gas purifying devices of motor vehicles, have been made of, for instance, ceramics. The honeycomb structure bodies have been manufactured by extrusion molding upon using a honeycomb structure-body molding die (hereinafter suitably referred to merely as a “metallic die”).

For the metallic die, a metallic die body has been used which is formed with material feed holes, through which a material is fed, and slit recesses formed under a lattice pattern in communication with the material feed holes for forming the material in a honeycomb shape as disclosed in U.S. Pat. Nos. 6,732,621 and 5,906,839.

In manufacturing such a metallic die, first, a die material is prepared as a material of the metallic die. Then, the die material is drilled to form the material feed holes on one surface of the die material in a depth not to pierce the same. Subsequently, the other surface of the die material is subjected to a grinding process with the use of a disc-like thin-blade grinding stone, thereby forming the slit recesses in the lattice pattern in communication with the material feed holes.

However, the manufacturing method of the related art has been encountered with various disadvantages such as the occurrence of increased grinding resistance when the slit recesses are formed. Further, during the grinding work, the disc-like thin-blade grinding stone is caused to tilt with a fear of gurges occurring in the slit recesses to be formed. This results in a difficulty of manufacturing the honeycomb structure-body molding die with a desired shape as profiled in design.

### SUMMARY OF THE INVENTION

The present invention has been completed with a view to addressing the above issues and has an object to provide a method of manufacturing a honeycomb structure-body molding die which can prevent the occurrence of damage to a grinding stone on a stage of forming a slit recess while preventing the occurrence of a gurge in the slit recess.

To achieve the above object, a first aspect of the present invention provides a method of manufacturing a honeycomb structure-body molding die formed with material feed holes and slit recesses formed in a lattice pattern in communication with the material feed holes, respectively, for molding the material into a honeycomb shape, the method comprising: a preparing step of preparing a die material having one side provided with a hole-processing surface, on which the material feed holes are formed, and the other side provided with a slit-processing surface on which the slit recesses are formed; a feed-hole forming step of forming the material feed holes each with a depth not to pierce the die material in a direction from the hole-processing surface toward the slit-processing surface; and a slit-recess forming step of forming the slit recesses in the die material from the slit-processing surface thereof to be brought into communication with the material feed holes, respectively. The slit-recess forming step includes a non-communication grinding process, in which a grinding work is conducted using a disc-like thin-blade grinding stone to form non-communication slit recesses on the slit-processing surface each in a depth not to communicate with the material feed holes, and a communication grinding process in which the grinding work is further conducted to grind the non-communication slit recesses into the slit recesses until the slit recesses are brought into communication with the material feed holes.

The manufacturing method of the present invention has a remarkable feature wherein during the slit-recess forming step, the non-communication grinding process and the communication grinding process are carried out.

According to the present invention, in forming the slit recesses in communication with the material feed holes, first, the non-communication grinding process is conducted to form the non-communication slit recesses in the die material on the slit-processing surface thereof. Subsequently, the communication grinding process is conducted to grind the non-communication slit recesses in further increased depths until the non-communication slit recesses are brought into communication with the material feed holes. That is, none of the slit recesses is formed by grinding at one time and the non-communication grinding process is conducted to form the slit recesses in relatively shallow states, i.e., to depths not to be brought into communication with the material feed holes. Thereafter, in the communication grinding process, the grinding work is further conducted to grind the non-communication slit recesses in further increased depths until the non-communication slit recesses are brought into communication with the material feed holes. Thus, the slit recesses are formed on the die material by grinding at least on two stages. This enables a remarkable reduction in grinding resistance acting on the grinding stone during the phase in which the slit recesses are formed.

In interruptive processing, generally, the grinding work is conducted with a resultant increase in grinding resistance with an inherent increase in load acting on a disc-like thin-blade grinding stone. Therefore, during a process of forming the slit recesses of the honeycomb structure-body molding die, if an attempt is made to perform interruptive processing with the disc-like thin-blade grinding stone inserted to a relatively deep area from a surface of a raw material, the disc-like thin-blade grinding stone suffers increased load, causing the disc-like thin-blade grinding stone to be easily damaged. In addition, the presence of the increase in grinding resistance results in a fear of a gurge occurring in the slit recess being formed.

According to the present invention, as set forth above, grinding work is done on two stages including the non-communication grinding process and the communication grinding process. This results in a reduction in grinding resistance, thereby preventing damage to the grinding stone while eliminating the gurge of the slit recess. Therefore, it becomes possible to easily manufacture a honeycomb structure-body molding die with a desired shape.

According to a second aspect of the present invention, there is provided a method of manufacturing a honeycomb structure-body molding die, the method comprising: preparing a die material having one side provided with a hole-processing surface and the other side provided with a convexed section protruding from upward from an upper surface of the die material and having a top provided with a slit-processing surface in opposition to the hole-processing surface; drilling the die material at the hole-processing surface thereof to form material feed holes such that hole ends of the material feed holes are ended at a nearly bottom portion of the convexed section; grinding the convexed portion of the die material at the slit-processing surface on a first stage in a lattice pattern to form non-communication slit recesses in a first given depth from the slit-processing surface of the convexed section not to communicate with the material feed holes; and grinding bottom portions of the non-communication slit recesses in a second given depth from the slit-processing surface of die convexed section to form slit recesses in communication with the material feed holes, respectively.

According to a second aspect of the present invention, the slit recesses are reliably formed on the convexed section of the die material on the first and second stages with a view to reducing grinding resistance for thereby precluding the occurrence of gurges in the slit recesses.

According to the second aspect of the present invention, more particularly, first, the die material is ground to form the non-communication slit recesses on the slit-processing surface such that none of the non-communication slit recesses does not communicate the hole ends of the material feed holes preliminarily formed in the die material at the hole-processing surface thereof. Subsequently, the bottom portions of the non-communication slit recesses are further grounded in an increased depth from the slit-processing surface of the convexed portion, thereby forming the slit recesses in communication with the material feed holes. That is, no single grinding work forms the slit recesses and the slit recesses are obtained through first and second grinding work on the first and second stages. This results in a remarkable reduction in grinding resistance acting on the grinding stone during the phase in which the slit recesses are formed.

In interruptive grinding work generally conducted in the related art, the grinding work is conducted with a resultant increase in grinding resistance with an inherent increase in load acting on a disc-like thin-blade grinding stone. Therefore, during a process of forming the slit recesses of the honeycomb structure-body molding die, if an attempt is made to perform interruptive grinding work with the disc-like thin-blade grinding stone inserted to a relatively deep area from a surface of a raw material, then, the disc-like thin-blade grinding stone suffers increased load, causing the disc-like thin-blade grinding stone to be easily damaged. In addition, the presence of the increase in grinding resistance results in a fear of a gurge occurring in the slit recess being formed.

According to the second aspect of the present invention, as set forth above, grinding work is done to perform the slit-recess forming step on two stages. This results in a reduction in grinding resistance, thereby preventing damage to the grinding stone while eliminating the gurge of the slit recess. Therefore, it becomes possible to easily manufacture a honeycomb structure-body molding die with a desired shape.

### BRIEF DESCRIPTION OF THE DRAWINGS

FIG. 1 is an illustrative view showing a honeycomb structure-body molding die on a side formed with slit recesses formed by manufacturing a method according to the present invention.

FIG. 2 is a cross-sectional view taken on line A-A of FIG. 1.

FIG. 3 is a perspective view showing an overall structure of a die material used for manufacturing the honeycomb structure-body molding die shown in FIG. 1.

FIG. 4 is an illustrative view showing the die material having a hole-processing surface formed with material feed holes in a preliminary drilling step.

FIG. 5A is an illustrative view showing the die material having a hole-processing surface formed with non-communication slit recesses formed on a first stage by grinding using a first disc-like thin-blade grinding stone.

FIG. 5B is an illustrative view showing the die material having the non-communication slit recesses further processed on a second stage by grinding using a second disc-like thin-blade grinding stone to form slit recesses in communication with the material feed holes.

FIG. 6 is an illustrative view showing a grinding tool as viewed in a direction from a side of a circular thin-blade grinding stone used for the manufacturing method of the present invention.

FIG. 7 is an illustrative view showing the grinding tool as viewed in a direction perpendicular to a thickness direction of the circular thin-blade grinding stone used for the manufacturing method of the present invention.

### DETAILED DESCRIPTION OF PREFERRED EMBODIMENTS

Now, a method of manufacturing a honeycomb structure-body molding die of one embodiment according to the present invention will be described below in detail with reference to the accompanying drawings. However, the present invention is construed not to be limited to such an embodiment described below and technical concepts of the present invention may be implemented in combination with other known technologies or the other technology having functions equivalent to such known technologies.

Now, a manufacturing method of the present invention will be described below in detail with reference to various aspects of the present invention.

In the method of manufacturing a honeycomb structure-body molding die according to the present invention, the honeycomb structure-body molding die is manufactured by carrying out the preparing step, the feed-hole forming step and the slit-recess forming step.

In the preparing step, a die material is prepared having one surface with a hole-processing surface for material feed holes to be formed and the other surface with a slit-processing surface on which slit recesses are formed in communication with the material feed holes.

Examples of the die material may include metals such as SKH (high-speed tool steel), SKD (alloy tool steel), stainless steel, aluminum alloy, titan, Inconel, Hastelloy, satellite, hard metal and cermet or the like or similar raw material.

In the feed-hole forming step, the material feed holes are formed on the die material at the hole-processing surface thereof so as to extend toward the slit-processing surface in depth not pierce the die material.

The material feed holes are formed by, for instance, drilling or the like. In addition, a drilling depth (depth of the material feed hole) may be determined to have an arbitrarily selected value depending on the die material to be manufactured.

In the slit-recess forming step, the slit recesses are formed on the slit-processing surface of the die material in communication with the material feed holes. The slit-recess forming step may be implemented by executing the non-communication grinding process and the communication grinding process.

In the non-communication grinding process, grinding processing is conducted using a disc-like thin-blade grinding stone to grind the slit-processing surface in a depth not to be brought into communication with the material feed holes, thereby forming non-communication slit recess. In this case, the depth of the grinding working can be arbitrarily selected provided that none of the non-communication slit recesses are brought into communication with the material feed holes.

Preferably, the die material may be ground at the slit-processing surface to form the slit recesses in a depth as deep as possible to be closer to the material feed holes. In this case, grinding resistance ca be further decreased during the communication grinding process. This further suppresses the occurrence of the disc-like thin-blade grinding stone from tilting while preventing damage to the disc-like thin-blade grinding stone.

Further, the non-communication grinding process may be carried out one or more than two times.

Conducting the non-communication grinding process on stages more than two times enables a reduction grinding resistance of the grinding stone during the non-communication grinding process. This results in a further reduction in the occurrence of a serpentine movement of the disc-like thin-blade grinding stone for thereby minimizing the occurrence of a gurge in the slit recess. This results in a further reduction of load acting on the disc-like thin-blade grinding stone. Meanwhile, since the number of man-hour increases, there is a fear of an increase in production cost. Therefore, the non-communication grinding process may be preferably carried out to form the non-communication slit recesses upon executing the grinding steps the number of times less than three times.

During the communication grinding process, the grinding work may be preferably implemented by inserting the disc-like thin-blade grinding stone in a further inward depth from the slit-processing surface of the die material than that achieved in the grinding work for the non-communication grinding process.

In such a case, during the communication grinding process, the grinding working can be easily conducted to cause the non-communication slit recesses, formed in the non-communication grinding process, to be connected to the material feed holes.

Further, during the non-communication grinding process and the communication grinding process, the grinding work may be preferably conducted upon replacement of the disc-like thin-blade grinding stone.

In such a case, it become possible to further prevent the occurrence of a defect such as a gurge in the slit recess to be formed due to damage occurred in the disc-like thin-blade grinding stone.

The disc-like thin-blade grinding stone may preferably have a pair of disc-like flanges, between which the disc-like thin-blade grinding stone is sandwiched, which have a given diameter. During the non-communication grinding process and the communication grinding process, the grinding work may be preferably conducted by replacing the disc-like thin-blade grinding stone with another disc-like thin-blade grinding stone sandwiched between disc-like flanges having a diameter smaller than the given diameter.

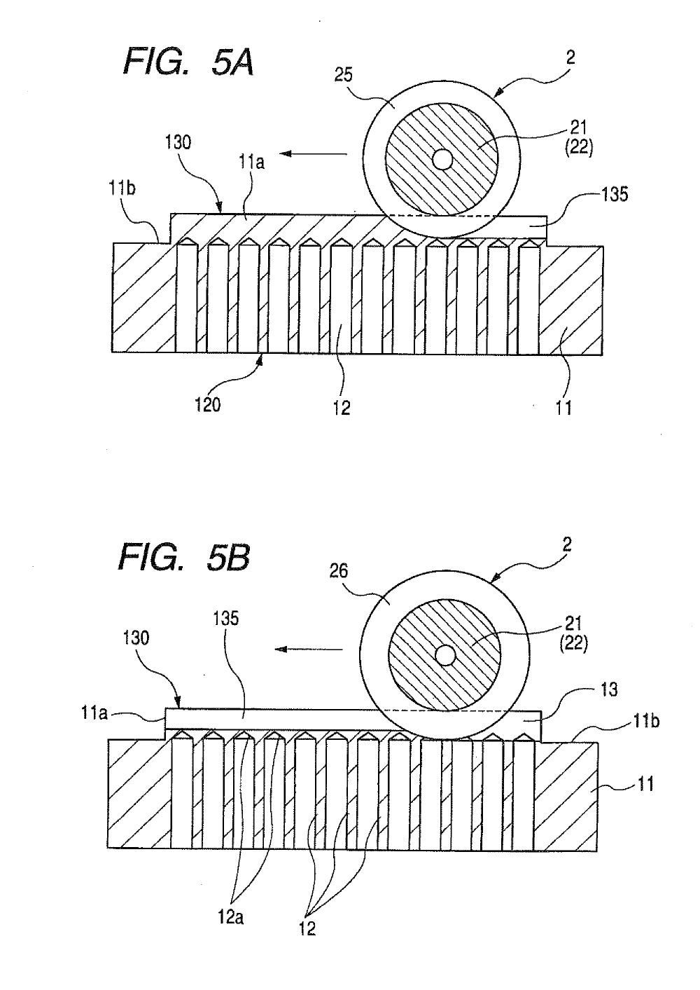

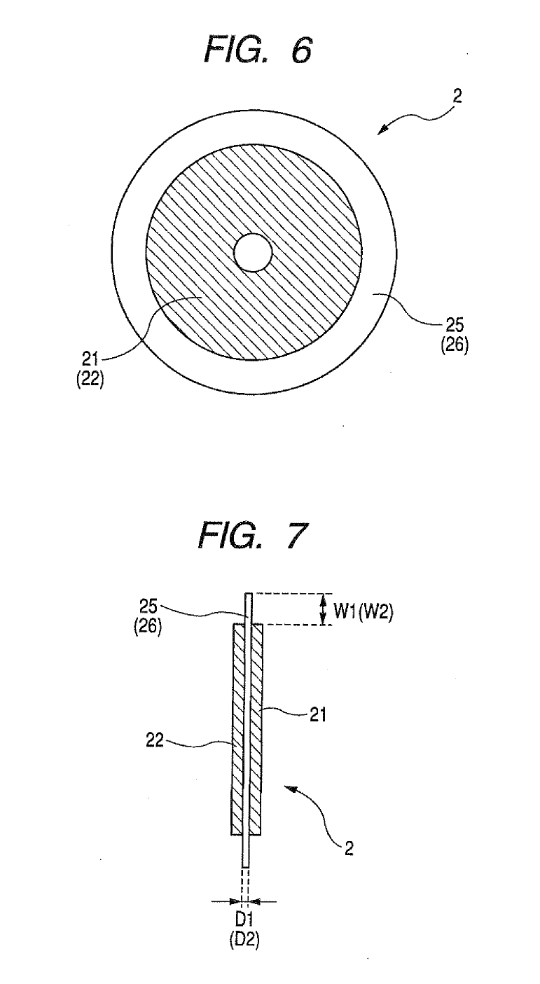

In this case, by properly altering the prominent blade portion W1 (W2) of the disc-like thin-blade grinding stone in an area exposed from the disc-like flanges, the non-communication grinding process and the communication grinding process can be performed to allow the grinding working to be achieved with a simply adjusted grinding depth (see FIGS. 6 and 7). In addition, implementing the grinding working with outer circumferences of the disc-like flanges to be held in abutting contact with the surface (slit-processing surface) of the die material allows the prominent blade portion to be nearly equal to the grinding depth, thereby enabling the adjustment of the depth to be achieved by the grinding working in a further simplified fashion (see FIGS. 5A and 5B).

Further, the disc-like thin-blade grinding stone may preferably have a given prominent blade portion operative in grinding operation. During the communication grinding process, the grinding work may be preferably conducted by replacing the disc-like thin-blade grinding stone with another disc-like thin-blade grinding stone having a prominent blade portion greater than the given prominent blade portion.

In this case, the non-communication grinding process can be performed to form the non-communication slit recesses and the communication grinding process can be performed to form the slit recesses both in simplified manners. In addition, the prominent blade portion W1 of the disc-like thin-blade grinding stone, used as the grinding tool for the non-communication grinding process, and the prominent blade portion W2 of the disc-like thin-blade grinding stone, used as the grinding tool for the communication grinding process, can be suitably selected to meet the honeycomb structure-body molding die to be manufactured.

Furthermore, for the disc-like thin-blade grinding stone, it has been a general practice to use a disc-like grinding stone with a blade thickness of the order of approximately 60 to 300 μm.

For the communication grinding process, it may be preferable to perform the grinding step using a disc-like thin-blade grinding stone having a blade thickness smaller than a blade thickness of the grinding stone used for the non-communication grinding process.

That is, it is preferred that D1 and D2 may preferably satisfy the relationship expressed as D1>D2 where D1 represents the blade thickness of the disc-like thin-blade grinding stone used for the non-communication grinding process and D2 represents the blade thickness of the another disc-like thin-blade grinding stone used for the communication grinding process.

If D1=D2, then, the communication grinding process is conducted with the occurrence of a fear of a difficulty being encountered in grinding the non-communication slit recesses, formed in the non-communication grinding process. If D1<D2, in contrast, there is a fear of causing an impossibility to be encountered in grinding the non-communication slit recesses.

A difference in D1−D2 between D1 and D2 may preferably fall in a value ranging from 0.1 to 10 μm where D1 represents the blade thickness of the disc-like thin-blade grinding stone used for the non-communication grinding process and D2 represents the blade thickness of the another disc-like thin-blade grinding stone used for the communication grinding process.

If D1−D2<0.1 μm, the communication grinding process has a fear of a difficulty encountered in inserting the disc-like thin-blade grinding stone to the non-communication slit recesses. This results in the occurrence of a difficulty of smoothly grinding the non-communication slit recesses. On the contrary, if D1−D2>10 μm, then, a relatively increased uneven portion occurs in the slit recesses to be formed. This causes stress to occur on the uneven portion to induce a defect when extrusion molding the material by using the honeycomb structure-body. More preferably, the difference in D1−D2 between D1 and D2 may fall in a range expressed by the relationship expressed as 0.5 μm≦D1−D2≦5 μm and, more preferably, in a range expressed by the relationship expressed as 1 μm≦D1−D2≦2 μm.

### EXAMPLE

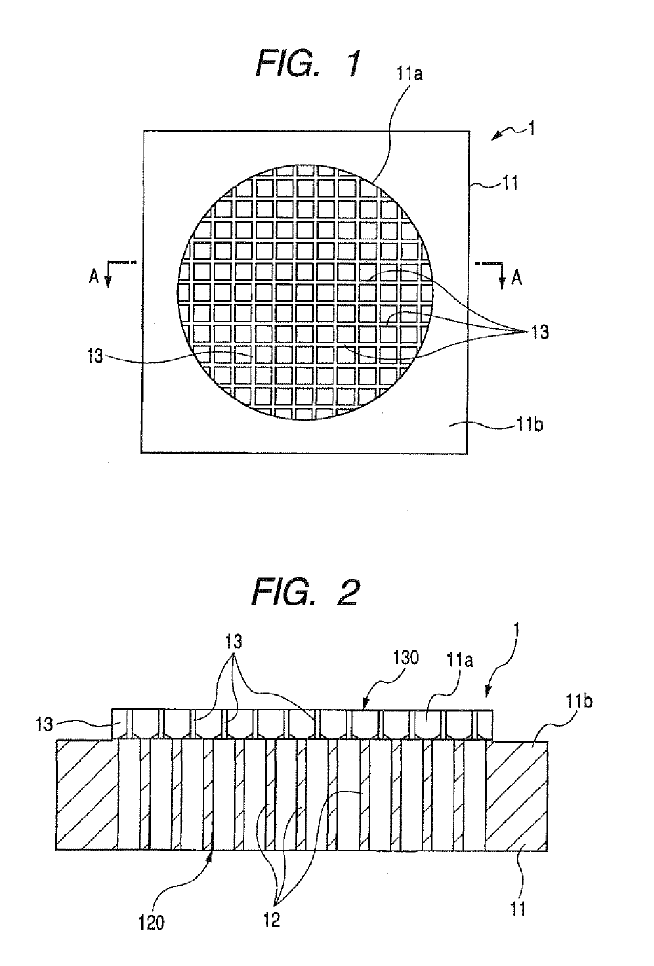

Now, a method for manufacturing a honeycomb structure-body molding die according to the present invention will be described below in detail with reference to FIGS. 1 to 7 of the accompanying drawings.

As shown in FIGS. 1 and 2, the manufacturing method of the present invention is implemented to manufacture a honeycomb structure-body molding die 1 (hereinafter suitably referred to merely as a “metallic die”) that is used for extrusion molding a material including, for instance, a ceramic material or the like to form a honeycomb structure body. The metallic die 1 includes a die material 11 formed with material feed holes 12 for supplying the material and slit recesses 13 formed under a lattice pattern in communication with the material feed holes 12, respectively, to form the material into a honeycomb shape.

In the present manufacturing method, a die-material preparing step, a feed-hole forming step and a slit-recess forming step are implemented to manufacture the metallic die 1.

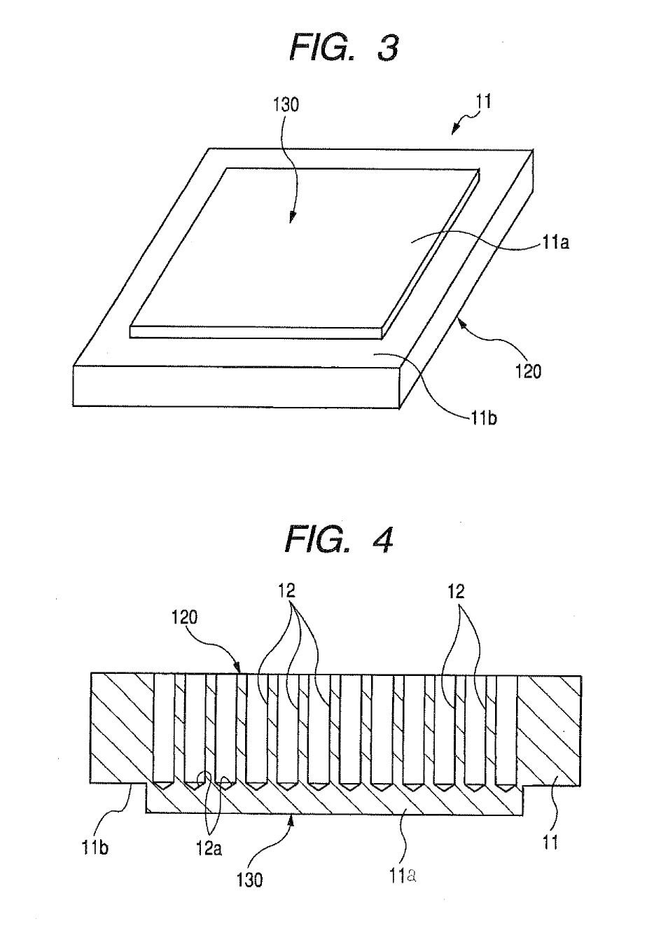

In the die-material preparing step, the die material 11 is prepared having one surface provided with a hole-processing surface 120 for the material feed holes to be formed and the other surface provided with a slit-processing surface 130 for the slit recesses to be formed as shown in FIG. 3.

In the feed-hole forming step, the material feed holes 12 are formed in the die material 11 at the hole-processing surface 120 thereof such that the material feed holes 12 extend toward the slit-processing surface 130 in a depth not to pierce the die material 11 as shown in FIG. 4.

In the slit-recess forming step, further, a non-communication grinding process (see FIG. 5A) and a communication grinding process (see FIG. 5B) are conducted. To this end, the slit-processing surface 130 of the die material 11 is grounded on first and second stages using disc-like thin-blade grinding stones 25 and 26, respectively, thereby forming the slit recesses 13 in communication with the material feed holes 12, respectively.

In the non-communication grinding process, using the disc-like thin-blade grinding stone 25 allows the slit-processing surface 130 of the die material 11 to be ground to form non-communication slit recesses 135 in a depth not to communicate with the material feed holes 12 as shown in FIG. 5A. In the communication grinding process, further the non-communication slit recesses 135 are further ground at the slit-processing surface 130 of the die material 11 using the disc-like thin-blade grinding stone 26 until the non-communication slit recesses 135 are formed in the slit recesses 13 in communication with the material feed holes 12 as shown in FIG. 5B.

Hereunder, the manufacturing method of the present invention will be described below farther in detail.

<Die-Material Preparing Step>

As show in FIG. 3, first, the die material 11 is prepared having one and the other surfaces provided with the hole-processing surface 120, in which the material feed holes 12 are formed, and the slit-processing surface 130 in which the slit recesses 13 are formed. To this end, a steel plate, made of SKD 61, is prepared as the die material 11. Further, the die material 11 is formed with a convexed section 11a that protrudes upward from one surface 11b of the die material 11 in opposition to the hole-processing surface 120. The convexed section 11a is preliminarily subjected to a preceding grinding process so as to have the slit-processing surface 130. The die material 11 is 16.5 mm thick between the hole-processing surface 120 and the slit-processing surface 130.

<Feed-Hole Forming Step>

As shown in FIG. 4, further, the material feed holes 12 are formed in the die material 11 at the hole-processing surface 120 in a given depth. In the illustrated Example, a drill processing was conducted on the hole-processing surface 120 to form the material feed holes 12 using a carbide drill in a depth of 13.9 mm from the hole-processing surface 120. The material feed holes 12 are formed in the die material 11 in the depth such that hole ends 12a of the material feed holes 12 slightly penetrate a bottom of the convexed section 11a. At this time point, none of the hole-processing surface 120 and the slit-processing 130 is pierced.

<Slit-Recess Forming Step>

Next, as shown in FIGS. 5A and 5B, the slit-processing surface 130 of the convexed portion 11a is ground on the first and second stages using the disc-like thin-blade grinding stones 25 and 26, respectively, thereby forming the slit recesses 13 in communication with the material feed holes 12, respectively.

In the slit-recess forming step, the non-communication grinding process and the communication grinding process are implemented.

For the non-communication grinding process and the communication grinding process, the grinding working is carried out using grinding tools 2. The grinding tools 2 includes the disc-like thin-blade grinding stones 25 and 26, respectively, each of which is sandwiched between two disc-like flanges 21 and 22 as shown in FIGS. 6 and 7. In the manufacturing method of the illustrated Example, the grinding tools of two types are used for the non-communication grinding process and the communication grinding process, respectively. In particular, the grinding tools include first and second disc-like thin-blade grinding stones with different diameters and blade thickness, which are used upon replacement for the non-communication grinding process and the communication grinding process.

More particularly, for the non-communication grinding process, the first grinding tool 2 (hereinafter suitably referred to as a “grinding tool A”) is used including the first disc-like thin-blade grinding stone 25 with a prominent blade portion W1 of 2.0 mm and a blade thickness D1 of 113 μm. For the communication grinding process, the grinding tool 2 (hereinafter suitably referred to as a “grinding tool B”) is used including the second disc-like thin-blade grinding stone 26 with a prominent blade portion W2 of 3.44 mm and a blade thickness D2 of 112 μm.

As shown in FIG. 5A, during the non-communication grinding process, the slit-processing surface 130 of the convexed section 11a is ground using the first disc-like thin-blade grinding stone 25 of the grinding tool 2 (grinding tool A) to a depth not to pierce the bottom of the convexed section 11a, thereby forming the non-communication slit recesses 135 that are not brought into communication with the material feed holes 12. During such a non-communication grinding process, the grinding tool A, composed of the first disc-like thin-blade grinding stone 25 having the prominent blade portion W1 of 2.0 mm, is used as the grinding tool A. In this case, the disc-like flanges 21 and 22 are held in abutting engagement with the slit-processing surface 130 during grinding work. Thus, grinding work can be achieved to form the non-communication slit recesses 135 on the convexed section 11a of the die material 11 to a depth of 2.0 mm. In such a way, the non-communication slit recesses 135 were formed on the convexed section 11a at the slit-processing surface 130 thereof in a square-shaped lattice pattern.

Next, as shown in FIG. 5B, for the communication grinding process, the second disc-like thin-blade grinding stone 26 of the grinding tool 2 (grinding tool B) was placed in the non-communication slit recess 135. Subsequently, a bottom portion of each non-communication slit recess 135 was ground to remove the hole end 12a, thereby forming the communication slit recess 13 in communication with each material feed hole 12.

During such a communication grinding process, the second disc-like thin-blade grinding stone 26 was employed as the grinding tool B with the prominent blade portion W2 of 3.44 mm. Therefore, with the disc-like flanges 21 and 22 held in abutting engagement with the slit-processing surface 130 of the convexed section 11a during lateral movement of the second disc-like thin-blade grinding stone 26, the bottom portion of the non-communication slit recess 135 was ground in a further increased depth by a value of 1.44 mm, thereby forming each slit recess 13 in communication with each of the material feed holes 12. In such a way, the slit recesses 13 were formed on the convexed portion 11a in a square-shaped lattice pattern.

Thereafter, the convexed portion 11a was formed in a circular shape, thereby obtaining the honeycomb structure-body molding die 1 (see FIGS. 1 and 2).

Next, advantageous effects of the manufacturing method of the present invention will be described below in detail.

As set forth above, in the slit-recess forming step for forming the slit recesses, the non-communication grinding process and the communication grinding process are implemented. During the non-communication grinding process, as shown in FIG. 5A, the slit-processing surface 130 of the convexed portion 11a forming the die material 11 is ground to form the non-communication slit recesses 135 in the depth not to communicate with the material feed holes 12. During the next communication grinding process, the bottom portions of the non-communication slit recesses 135 are further ground using the second disc-like thin-blade grinding stone 26 in a further increased depth, thereby forming the slit recesses 13 in communication with the material feed holes 12 as shown in FIG. 5B.

That is, no single grinding work forms the slit recesses 13 and, instead, grinding work is conducted on at least two stages. On initial grinding work, the first disc-like thin-blade grinding stone 25 is used to form the non-communication slit recesses 135 on the convexed section 11a of the die material 11 in relatively shallow depths not to communicate with the material feed holes 12. On second grinding work, the second disc-like thin-blade grinding stone 26 is used to further grind the bottom portions of the non-communication slit recesses 135 in further increased depths, thereby forming the slit recesses 13 in connection to the material feed holes 12.

Therefore, the slit-forming step can be achieved in reduced grinding resistance. This prevents the disc-like thin-blade grinding stones 25 and 26, each having a reduced blade thickness, from tilting and causing gurges to occur in the slit recesses 13 during grinding work. In addition, this results in a decrease in load acting on the disc-like thin-blade grinding stones 25 and 26, thereby preventing damage to the grinding stones 25 and 26.

On the contrary, if intermittent machining is performed to grind a die material with a disc-like thin-blade grinding stone caused to penetrate in a relatively increased depth from a surface of the die material, grinding resistance remarkably increases. This causes a fear of the gurges occurring in the slit recesses 13. This result in further increased load acting on the disc-like thin-blade grinding stone, which is easily damaged as a consequence.

As set forth above, in the present manufacturing method, the slit-recess forming step is performed in the non-communication grinding process and the communication grinding process on at least two stages. This enables a remarkable reduction in grinding resistance, thereby preventing damage to the grinding stone while avoiding the occurrence of gurges caused in the slit recesses 13. Therefore, it becomes possible to simply manufacture a honeycomb structure-body molding die with a desired shape in a highly reliable fashion.

In the manufacturing method of the present invention, during the communication grinding process, grinding work is carried out by deeply inserting the second disc-like thin-blade grinding stone 26 from the slit-processing surface 130 into the non-communication slit recesses 135 in a further increased depth than that in which the grinding stone 25 is inserted to the con-vexed section 11a (see FIGS. 5A and 5B). Thus, during the communication grinding process, the bottom portions of the non-communication slit recesses 135, formed in the non-communication grinding process, can be easily connected to the material feed holes 12 by grinding.

In the manufacturing method of the present invention, furthermore, the non-communication grinding process and the communication grinding process are performed upon replacement of the disc-like thin-blade grinding stones 25 and 26. This result in a further reduction in the occurrence of gurges caused in the slit recesses 13 during the forming step thereof due to the presence of wears caused in the disc-like thin-blade grinding stones 25 and 26 (see FIGS. 5A and 5B).

During the non-communication grinding process and the communication grinding process, further, the first and second grinding tools A and B are used including the first disc-like thin-blade grinding stone 25, having the disc-like flanges 21 and 22 with a first diameter, and the second disc-like thin-blade grinding stone 26 having the disc-like flanges 21 and 22 with a second diameter greater than the first diameter. This makes it possible to simply adjust the depth of the slit recesses to be ground in the non-communication grinding process and the communication grinding process. This is made by properly altering the prominent blade portions W1 and W2 of the first and second disc-like thin-blade grinding stones 25 and 26 in areas protruding from the disc-like flanges 21 and 22 (see FIGS. 6 and 7). Further, each grinding work is done using each grinding stone with the disc-like flanges 21 and 22 having the outer circumferential peripheries held in abutting contact with the slit-processing surface 130 of the die material 11. This allows grinding work to be conducted in a depth nearly equal to the prominent blade portion of each grinding stone, thereby enabling the depth of the slit recess formed by grinding to be more easily adjusted (see FIGS. 5A and 5B).

During the communication grinding process of the manufacturing method of the present invention, moreover, grinding work is performed using the grinding tool B including the second disc-like thin-blade grinding stone 26 with the prominent blade portion greater than that of the first disc-like thin-blade grinding stone 25 used for the non-communication grinding process. This result in capability of simply forming the non-communication slit recesses 135 in the non-communication grinding process on one stage and forming the communication slit recesses 13 in the communication grinding process on the other stage (see FIGS. 5A and 5B).

During the communication grinding process of the manufacturing method of the present invention, grinding work is done using the second disc-like thin-blade grinding stone 26 with a blade thickness smaller than that of the first disc-like thin-blade grinding stone 25 used for the non-communication grinding process. This satisfies the relationship expressed as D1>D2 where D1 represents the thickness of the first disc-like thin-blade grinding stone 25, used for the non-communication grinding process, and D2 represents the thickness of the second disc-like thin-blade grinding stone 26 used for the communication grinding process. In addition, with the manufacturing method of the present invention, a thickness difference, i.e., a difference in D1−D2 between D1 and D2 falls in a value ranging from 0.1 to 10 μm, Therefore, as shown in FIG. 5B, during the communication grinding process, the second disc-like thin-blade grinding stone 26 can be smoothly inserted to the bottom portions of the non-communication slit recesses 135. This enables grinding work to be simply initiated to grind the bottom portions of non-communication slit recesses 135. Moreover, it becomes possible to preclude the occurrence of increased uneven portions in each of the slit recesses 13.

While the specific embodiment of the present invention, has been described in detail, it will be appreciated by those skilled in the art that various modifications and alternatives to those details could be developed in light of the overall teachings of the disclosure. Accordingly, the particular arrangement disclosed is meant to be illustrative only and not limited to the scope of the present invention, which is to be given the fall breadth of the following claims and all equivalents thereof.

What is claimed is:

1. A method of manufacturing a honeycomb structure-body molding die formed with material feed holes and slit recesses formed in a lattice pattern in communication with the material feed holes, respectively, for molding the material into a honeycomb shape, the method comprising:
a preparing step of preparing a die material having one side provided with a hole-processing surface, on which the material feed holes are formed, and the other side provided with a slit-processing surface on which the slit recesses are formed;
a feed-hole forming step of forming the material feed holes each with a depth not to pierce the die material in a direction from the hole-processing surface toward the slit-processing surface; and
a slit-recess forming step of forming the slit recesses in the die material from the slit-processing surface thereof to be brought into communication with the material feed holes, respectively;
the slit-recess forming step including a non-communication grinding process, in which a grinding work is conducted using a disc-like thin-blade grinding stone to form non-communication slit recesses on the slit-processing surface each in a depth not to communicate with the material feed holes, and a communication grinding process in which the grinding work is further conducted to grind the non-communication slit recesses into the slit recesses until the slit recesses are brought into communication with the material feed holes.

2. The method of manufacturing a honeycomb structure-body molding die according to claim 1, wherein:
during the communication grinding process, the grinding work is implemented by inserting the disc-like thin-blade grinding stone in a further inward depth from the slit-processing surface of the die material than that achieved in the grinding work for the non-communication grinding process.

3. The method of manufacturing a honeycomb structure-body molding die according to claim 1, wherein:
during the non-communication grinding process and the communication grinding process, the grinding work is conducted upon replacement of the disc-like thin-blade grinding stone.

4. The method of manufacturing a honeycomb structure-body molding die according to claim 1, wherein:
the disc-like thin-blade grinding stone has a pair of disc-like flanges, between which the disc-like thin-blade grinding stone is sandwiched, which have a given diameter; and
wherein during the non-communication grinding process and the communication grinding process, the grinding work is conducted by replacing the disc-like thin-blade grinding stone with another disc-like thin-blade grinding stone sandwiched between disc-like flanges having a diameter smaller than the given diameter.

5. The method of manufacturing a honeycomb structure-body molding die according to claim 4, wherein:
the disc-like thin-blade grinding stone has a given prominent blade portion operative in grinding operation; and
wherein during the communication grinding process, the grinding work is conducted by replacing the disc-like thin-blade grinding stone with another disc-like thin-blade grinding stone having a prominent blade portion greater than the given prominent blade portion.

6. The method of manufacturing a honeycomb structure-body molding die according to claim 2, wherein:
the disc-like thin-blade grinding stone has a given blade thickness;
wherein during the communication grinding process, the grinding work is conducted by replacing the disc-like thin-blade grinding stone with another disc-like thin-blade grinding stone having a blade thickness smaller than the given blade thickness.

7. The method of manufacturing a honeycomb structure-body molding die according to claim 6, wherein:
a difference between D1 and D2 lies in a value ranging from 0.1 to 10 μm where D1 represents the blade thickness of the disc-like thin-blade grinding stone used for the non-communication grinding process and D2 represents the blade thickness of the another disc-like thin-blade grinding stone used for the communication grinding process.

8. A method of manufacturing a honeycomb structure-body molding die, the method comprising:
preparing a die material having one side provided with a hole-processing surface and the other side provided with a convexed section protruding from upward from all upper surface of the die material and having a top provided with a slit-processing surface in opposition to the hole-processing surface;
drilling the die material at the hole-processing surface thereof to form material feed holes such that hole ends of the material feed holes are ended at a nearly bottom portion of the convexed section;
grinding the convexed portion of the die material at the slit-processing surface on a first stage in a lattice pattern to form non-communication slit recesses in a first given depth from the slit-processing surface of the convexed section not to communicate with the material feed holes; and
grinding bottom portions of the non-communication slit recesses in a second given depth from the slit-processing surface of the convexed section to form slit recesses in communication with the material feed holes, respectively.

9. A honeycomb structure-body molding die manufactured by the method as defined claim 1.
